(19) United States
(12) Patent Application Publication
(10) Pub. No.: US 2020/0115236 A1
(43) Pub. Date: Apr. 16, 2020

(54) METHOD FOR THE PRODUCTION OF PELLETS OF SINTERED MATERIAL, SUCH AS BORON CARBIDE PELLETS

(71) Applicant: COMMISSARIAT À L'ÉNERGIE ATOMIQUE ET AUX ÉNERGIES ALTERNATIVES, Paris (FR)

(72) Inventors: Aurélien Jankowiak, Limours (FR); Nicolas Lochet, Saint Cheron (FR)

(21) Appl. No.: 16/626,808

(22) PCT Filed: Jun. 28, 2018
(86) PCT No.: PCT/FR2018/051591

§ 371 Date: Dec. 26, 2019

(30) Foreign Application Priority Data
Jun. 30, 2017 (FR) 1756103

(51) Int. Cl. C01B 32/991; B28B 3/02; B28B 3/06

(52) U.S. Cl. CPC C01B 32/991; B28B 3/06; B28B 3/025

(57) ABSTRACT

A method for producing pellets of sintered material, comprising: a) forming calibrated pre-compacts by first uniaxial pressing of equal portions powder at a first threshold below the maximum green density threshold of the powder; b) providing a pressing tool set comprising a die having a plurality of cavities and pressure pistons; c) placing the pre-compacts in the cavities with first and second sintered boron nitride disks, having a thickness in the millimetre range and a density >=90%; d) forming calibrated compacts by second uniaxial pressing of the pre-compacts using the pressure pistons at a second threshold greater than the first threshold, which is less than or equal to the maximum green density of the powder; e) forming sintered compacts by applying pressure and a pulsed current to the pressing tool set to bring about a rapid rise in temperature according to a temperature-, pressure- and duration-controlled SPS sintering cycle.

### TECHNICAL FIELD

The field of the invention is manufacturing of elements made of a high density sintered material, and particularly ceramic elements made of boron carbide (B₄C).

### STATE OF PRIOR ART

The materials produced by sintering of powders can contain a residual void ratio. The real density of the sintered material is then less than its theoretical density.

It will be remembered that the theoretical density (or the crystallographic density) corresponds to the density of the monocrystal and can be calculated from the chemical composition and from the crystalline structure. The relative density (or real density), expressed as a percentage of the theoretical density, includes the porosity, defects in the crystallographic lattice and secondary phases.

However for some applications, it may be necessary to obtain sintered materials with a high density. Therefore, some sintering methods that cannot achieve a suitable density, may not be suitable.

This is the case for example for boron carbide (B₄C) intended for nuclear use, that is used mainly as a neutron absorber in nuclear reactors. It is usually in the form of cylindrical pellets obtained by sintering a B₄C powder, that can be enriched in ¹⁰B. B₄C pellets for nuclear use must have a relative density of at least 96% and an essentially closed porosity, to prevent the possibility of sodium being trapped.

These B₄C pellets for nuclear use have up to now been made industrially by “Hot Pressing” (HP) type of sintering using multi-cavity dies (in other words dies comprising several moulding cavities). For example, HP sintering was used in particular for making boron carbide pellets for PHENIX and SUPERPHENIX nuclear reactors.

Use of the HP method can achieve the required minimum relative density of 96%, but with a small margin which leads to a significant and expensive non-conformity ratio (especially if the B₄C is enriched in ¹⁰B) and in the presence of open porosity. Furthermore, due to the long thermal cycles, the microstructure of the sintered materials obtained by HP sintering can change, and particularly the grain size, which can lead to a reduction in the mechanical performances of the sintered material in comparison with materials with a finer microstructure.

Among other known sintering techniques, mention may be made of SPS (Spark Plasma Sintering) sintering.

The main difference between the HP sintering method and the SPS sintering method lies in the manner of heating the powder compact. Heating is indirect during HP sintering: it is done using internal resistances in the furnace. The sample is heated by thermal conduction from the pressing die to the powder compact. During SPS heating, heating is direct: a pulsed electrical current passes through the compression tool (die and pistons) and/or the powder compact to be sintered, thus assuring heating by the Joule effect and by thermal conduction.

Starting from identical powders, SPS sintering can obtain denser materials and finer microstructures than HP sintering. This latter point is due to the fact that sintering cycle times are shorter and the duration of the temperature plateau is shorter in SPS sintering than in HP sintering.

Therefore SPS sintering makes it possible to optimise microstructures of sintered material, while having significantly shorter cycle times than with HP sintering. However, for high temperatures (in other words temperatures higher than 1200° C.), SPS sintering is done mainly using a single-cavity die, which can be used for the manufacturing of a single pellet or cake, and is therefore not suitable for manufacturing at industrial scale.

### PRESENTATION OF THE INVENTION

The inventors set themselves the objective of easily, quickly and efficiently making sintered materials with a finer microstructure and higher density than is possible for materials produced using the HP method, leading to a reduction in the presence of open pores, and an improvement in the mechanical properties of the sintered material. This latter point is particularly important in the case of pellets of B₄C intended for nuclear use, because an improvement to the mechanical properties of the material would provide better resistance to the temperature gradient in the reactor, bad resistance being the main cause of mechanical degradation of the sintered material during operation.

To achieve this, the inventors used the SPS method, providing improvements to it. As mentioned above, the SPS method can be used to manufacture parts individually (single-cavity tool), which is incompatible with large scale industrial manufacturing. Unlike HP sintering, in which multi-cavity dies are used frequently and easily because heating makes use of a peripheral heating element, in SPS sintering this type of tooling exists but requires adaptations to the process for the case of our applications at high temperatures. The first tests performed in a laboratory, without these adaptations and with conventional HP type multi-cavity dies, showed the presence of heterogeneities in the density and microstructure in pellets of sintered material, with the local formation of craters due to the passage of current.

Therefore the invention relates to a method for manufacturing pellets of sintered material comprising the following steps in sequence:
a) formation of pre-compacts calibrated by a first uniaxial compaction on portions with equal masses of material in powder form, this first compaction being made to a first threshold below the maximum unbaked density threshold achievable for the powder material;
b) supply of a compression tool (that can also be called a compaction or pressing tool) comprising a die with a plurality of cavities and pistons designed to slide in the cavities;
c) placement of pre-compacts in the cavities of the die, first and second disks made of sintered boron nitride, with millimetric thickness and density greater than or equal to 90% being arranged in each cavity at a first and at a second end of each pre-compact;
d) formation of calibrated compacts by a second uniaxial compaction on the pre-compacts, this second compaction being made in the die by means of compression pistons to a second threshold higher than the first threshold that is less than or equal to the maximum unbaked density threshold achievable for the powder material;
e) formation of sintered compacts by loading and under a pulsed current in the compression tool, so as to induce a fast temperature rise in an SPS sintering cycle with regulated temperature, pressure and duration;
f) extraction of sintered compacts from the die.

The first and the second compactions are obtained by the application of a uniaxial force.

The maximum achievable unbaked density for the powder material is the maximum density that can be achieved with a powder under the effect of a pressure applied to it.

Preferably, the purity of the first and second sintered boron nitride disks is greater than or equal to 99.7%.

Preferably, the cavities of the die are distributed symmetrically and at equal distance from the periphery. In the case of a die with a cylindrical external shape, the cavities may for example be arranged on a circle 13 centred on the axis of the cylinder, at equal distances from each other, as illustrated in FIG. 1b in which the die comprises four cavities. This configuration enables better temperature uniformity.

According to one preferred embodiment of the invention, the method also comprises a step between step b) and step c) in which a graphite film is applied to cover an internal wall of each cavity that will come into contact with the pre-compacts, and a piston contact face that will come into contact with one of the first and second boron nitride disks. The graphite film prevents pollution of cavities in the die and facilitates removal of the sintered compacts from the mould. For example, it may be a graphite foil or disk sold under the tradename Papyex™ by the MERSEN company.

Advantageously, the method also comprises another step between step b) and step c) in which a graphite film is applied to cover interfaces between the pre-compacts and the first boron nitride disks, and interfaces between the pre-compacts and the second boron nitride disks. The graphite film may be a Papyex™ graphite disk; it limits the potential adhesion of boron nitride in the first and second disks to the surface of the sintered pellets.

Preferably, the sintered material is boron carbide (B₄C).

### BRIEF DESCRIPTION OF THE DRAWINGS

Other characteristics and advantages of the invention will become clear after reading the following detailed description of preferred embodiments of the invention, given as non-limitative examples, with reference to the appended drawings among which:

FIG. 1a is a diagrammatic representation of an example of a piston and a compression die comprising four cavities, in a perspective view;

FIG. 1b is a diagrammatic representation of the compression die in FIG. 1a, showing a top view;

FIG. 2 is a sectional view of a compression tool ready to be inserted in a chamber of an SPS device;

FIG. 3 shows a partial cross-sectional view of an example of an SPS sintering device that can be used for implementation of the method according to the invention.

It should be noted that the different elements are not shown to scale in the figures.

### DETAILED PRESENTATION OF A PARTICULAR EMBODIMENT

The method according to the invention can be used to make pellets of a high density sintered material using the SPS sintering method in a multi-cavity die. This method is particularly useful for manufacturing high density B₄C pellets at an industrial scale for nuclear use. These high density B₄C pellets can be used particularly as neutron absorbers, particularly in 4^{th} generation fast neutron reactors.

The use of a multi-cavity die in SPS sintering requires perfect control of the current and particularly its path in the compression tool. A bad current distribution will generate hot points and lead to the formation of heterogeneities within the sintered materials.

In order to manufacture pellets of a high density sintered material, and particularly B₄C pellets, using the method according to the invention, two essential points have to be guaranteed.

Firstly, the compression tool has to be balanced and the piston height has to be adjusted.

This is done by making calibrated pre-compacts starting from portions of powder (with equal masses weighed using a high precision weighscale) by a first uniaxial pressing to a first threshold lower than the maximum achievable unbaked density threshold of the powder material, then they are put into the multi-cavity die. A second uniaxial pressing of the pre-compacts is then made to a second threshold that is higher than the first threshold and that is close to the maximum unbaked density achievable for the powder material in a multi-cavity die. Preferably, the second threshold is located as close as possible (if possible equal to) the maximum density threshold achievable for the unbaked powder material. Each of the calibrated compacts thus has an equivalent density. It should be noted that the first pressing is preferably made in a single-cavity die, but it could perfectly well be made in the multi-cavity die used for the second pressing.

Thus, the compression tool is balanced and the piston height is constant. This enables the application of an equivalent (uniform) pressure on all pre-compacts during the advance movement of the pistons during the heat treatment in SPS sintering. This ensures the most uniform possible current distribution and therefore a more uniform temperature distribution, particularly for large volume compression tools. Furthermore, this second compaction maintains the multi-cavity die on the lower pistons, without it sliding when it is in the vertical position. The compacts bear on the lower faces of the cavities of the multi-cavity die.

The risk of hot points also has to be eliminated and the current necessary for SPS sintering must be channelled away from bearing points between the pistons and the pre-compacts.

This is done using sintered boron nitride (BN) disks with a millimetric thickness (for example, 2.5 mm thick) and high purity (≥99.7%). For example, BN disks sold under the tradename Combat® BN grade AX05 made by the Saint Gobain company can be used. These disks are placed above and below the pre-compacts in the cavities of the die.

The presence of these disks assures that no current will pass from the pistons to the pre-compacts (no hot point), including for very high currents due to the significant thickness of BN disks compared with the thickness of a deposit made by spraying a suspension. Current will bypass the boron nitride disks since the disks form an electrically insulating layer, including at very high temperature.

Since the current distribution is controlled and uniform, the temperature of the pre-compacts is more uniform. The result is better uniformity in terms of density and microstructure (grain size) throughout the volume of the pellets.

The dense nature of the disks guarantees their mechanical strength and greater robustness than deposits with low cohesion made by spraying.

The millimetric thickness of the disks is such that the disks can resist SPS sintering temperatures, in other words temperatures higher than 1000° C., that can approach 2000° C. under controlled atmosphere.

Finally, unlike a fine and porous deposit of boron nitride made by spraying, a dense disk with millimetric thickness prevents potential pollution of the compact because it is much less fragile.

In order to illustrate the method according to the invention, we will now describe an example embodiment of high density B₄C pellets.

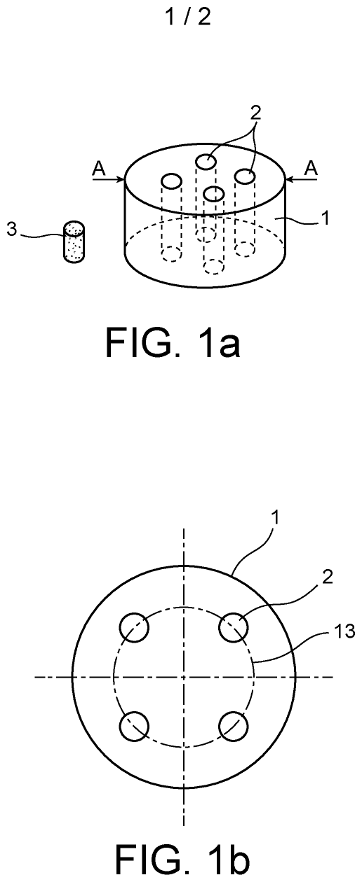

In this example embodiment, we made the pre-compacts 7 using a stainless steel single-cavity die provided with a through moulding cavity, and two stainless steel pistons that will slide in the moulding cavity to compact the powder in the cavity and thus form the pre-compacts 7. To make the calibrated compacts, we used a graphite compression tool comprising a multi-cavity die 1 provided with four through moulding cavities 2 distributed symmetrically in a circular layout within the die, as illustrated in FIG. 1b, and eight pistons 3 (only one piston being shown on FIG. 1a) that will slide inside the cavities 2 to compact the pre-compacts 7 in the cavities and thus form calibrated compacts with the required shape and dimensions. The pistons operate in pairs and displace in opposite directions during the compression.

The diameter of the cavity in the single-cavity die is 20 mm and the diameter of the cavities in the multi-cavity die is 20.4 mm, the difference allowing for the 200 μm thickness of Papyex™.

In our example embodiment, the four cavities of the multi-cavity die are 120 mm high.

HS grade B₄C powder from H. C. Starck was used as the raw material to form four portions with the same mass (15.60 g).

To make the pre-compacts 7, one of the powder portions was added into the cavity of the stainless steel single-cavity compression die and a first uniaxial compaction was made at low pressure (<10 MPa) at a density less than the maximum value achievable with the powder, namely 1 MPa for 1 minute. These operations were repeated for each powder portion.

The pre-compacts 7 thus obtained were then extracted from the single cavity die and stored while waiting to be used later.

A piece of Papyex™ foil 4 was cut to the internal dimensions of the internal lateral wall of each of the cavities of the multi-cavity die 1 and was placed on this internal lateral wall in each cavity.

The four lower pistons 3 are inserted in the lower part of the cavities and a Papyex Disk™ 6 with the same dimension as the head of the lower piston is placed in the bottom of each cavity.

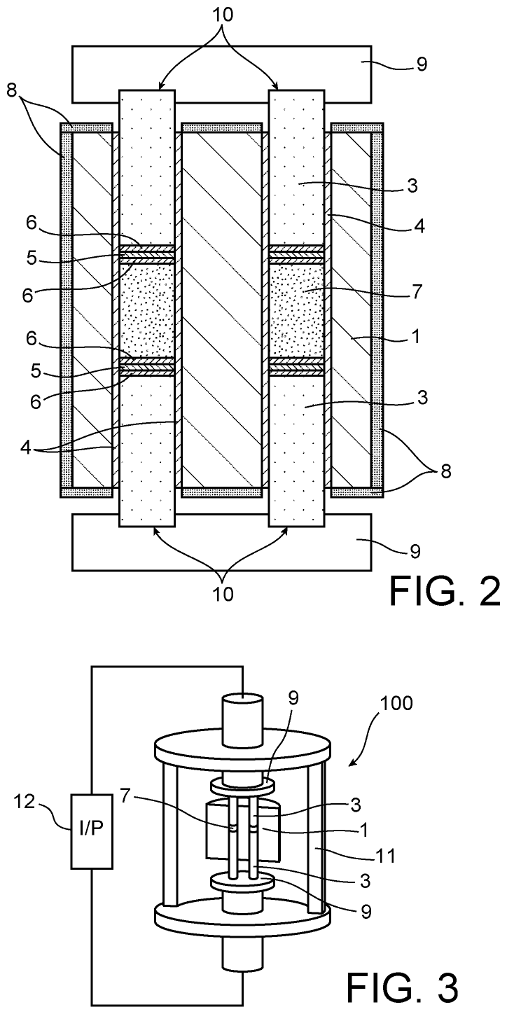

Note that the terms “lower” and “upper”, “bottom” and “top”, “below” and “above” refer to elements as shown on FIG. 2.

A 2.5 nm thick Combat® BN grade AX05 lower disk 5 is then inserted in each cavity.

The four pre-compacts 7 are introduced in the cavities 2 of the die.

According to one advantageous variant of the invention, a Papyex™ disk 6 is placed at the bottom and the top of the pre-compacts 7.

A 2.5 nm thick AX05 type BN upper disk 5 is then inserted in each cavity.

And a Papyex™ disk 6 with the same dimension as the head of the upper piston is placed on the BN upper disk.

The four upper pistons are inserted in the cavities so as to close the cavities.

The assemblies represented in FIG. 2 are thus obtained. It should be noted that the die as shown in FIG. 2 is a sectional view along line AA in FIG. 1a. Graphite plates 9 can conduct current and apply pressure uniformly on the pistons. In this embodiment, each of these plates 9 comprises four cylindrical cavities 10 machined in one of their faces. In this case, these cavities 10 have a diameter of 20.5 mm and a depth of 1 mm. They enable the pistons to anchor in them and hold the plates in place.

Maximum compaction is then made at high pressure to a threshold close to the maximum achievable unbaked density for the powder material. A pressure of 50 MPa is applied for 1 minute.

The next step is to cut the felt 8 made of a thermally insulating material, for example a graphite felt, to the dimensions of the die and it is placed above, below and around the die so as to limit thermal radiation during SPS sintering.

The die thus prepared is then placed in a chamber of an SPS sintering device 100 (FIG. 3) and a vacuum is created in the chamber 11. FIG. 3 represents an example of an SPS sintering device 100 for use of the device according to the invention, this device comprising in particular a chamber 11 and means 12 of applying a current and a load (or pressure) on the compression die 1. It should be noted that for simplification reasons, the die as shown on FIG. 3 only comprises two cavities and the Papyex™ foil and disks, and the boron nitride disks have not been shown.

The SPS sintering cycle is then performed, simultaneously applying a pressure and a pulsed electric current to increase the temperature of the compacts to a sufficiently high temperature plateau to cause sintering of the powder in the compacts.

In SPS sintering, the time during which the temperature plateau is maintained is relatively short and is generally between several seconds and several minutes (usually less than 10 minutes).

In a known manner, the temperature plateau, the pressure and the duration are optimised to obtain the required density.

In our example embodiment, SPS sintering was done at a pressure of 20 MPa per piston, with a temperature increase of 50° C./min, a temperature plateau of 2000° C. for a duration of 2 minutes, applying a maximum current of 5540 A.

The pressure and the temperature are then lowered and four pellets of sintered compacts are extracted from the die.

The pellet surface may possibly be ground so as to eliminate residual traces of Papyex™ and BN, for example by polishing with abrasive paper, using a diamond disk or a grinder fitted with a diamond tool.

The four pellets thus obtained only have an average relative density of 99.33% as measured by hydrostatic weighing, with a standard deviation of 0.03%.

Therefore the method according to the invention can increase the relative density of B₄C after sintering compared with the Hot Pressing method under similar temperature and pressure conditions. Note that the relative density that can be obtained using the HP method is of the order of 96%.

It also makes it possible to refine the microstructure of the sintered material, which in the case of the B₄C material, can increase the mechanical strength of the sintered material so that it has better resistance to the temperature gradient during use. Since by definition, an SPS sintering cycle is very short, enlargement of the grains is very small compared with an HP sintering cycle.

The method can also increase productivity compared with conventional SPS sintering due to the use of multi-cavity tooling and short sintering cycles.

We have illustrated the method according to the invention by manufacturing of B₄C pellets, but the method can be applied to manufacturing of any element made of a sintered material and is particularly useful for applications for which it is necessary to obtain high density sintered material.

What is claimed is:

1. Method for manufacturing pellets of sintered material comprising the following steps in sequence:
a) formation of pre-compacts calibrated by a first uniaxial compaction on portions with equal masses of material in powder form, this first compaction being made to a first threshold below the maximum unbaked density threshold achievable for the powder material;
b) supply of a compression tool comprising a die with a plurality of cavities and compression pistons designed to slide in the cavities;
c) placement of the pre-compacts in the cavities of the die, first and second disks made of sintered boron nitride, with millimetric thickness and density greater than or equal to 90% being arranged in each cavity at a first and at a second end of each pre-compact;
d) formation of calibrated compacts by a second uniaxial compaction on the pre-compacts, this second compaction being made in the die by means of compression pistons to a second threshold higher than the first threshold that is less than or equal to the maximum unbaked density threshold achievable for the powder material;
e) formation of sintered compacts by loading and under a pulsed current in the compression tool, so as to induce a fast temperature rise in an SPS sintering cycle with regulated temperature, pressure and duration;
f) extraction of sintered compacts from the die.

2. Method according to claim 1, further comprising a step between step b) and step c) in which a graphite film is applied to cover an internal wall of each cavity that will come into contact with the pre-compacts, and a compression piston contact face that will come into contact with one of the first and second boron nitride disks.

3. Method according to claim 2, further comprising another step between step b) and step c) in which a graphite film is applied to cover interfaces between the pre-compacts and the first boron nitride disks, and interfaces between the pre-compacts and the second boron nitride disks.

4. Method according to claim 1, wherein the sintered material is boron carbide (B₄C).
